(19) United States
(12) Patent Application Publication
(10) Pub. No.: US 2006/0126726 A1
(43) Pub. Date: Jun. 15, 2006

(54) Digital signal processing structure for decoding multiple video standards

(76) Inventors: Teng Chiang Lin, San Jose, CA (US); Hongjun Yuan, San Jose, CA (US); Weimin Zeng, San Jose, CA (US); Liang Peng, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/137,971

(22) Filed: May 25, 2005

Related U.S. Application Data
(60) Provisional application No. 60/635,114, filed on Dec. 10, 2004.

(51) Int. Cl. H04N 11/04; H04N 7/12; H04N 11/02; H04B 1/66

(52) U.S. Cl. 375/240.03; 375/240.25; 375/240.23; 375/240.24; 375/240.2; 375/240.12

(57) ABSTRACT

In one embodiment, a DSP structure includes four main sections: DEQ, IDCT for row, IDCT for column, and motion compensation. The data input sequence is organized in such a way to facilitate the data loading into hardware structures for row IDCT and column IDCT. Two types of decoding flows are enabled by the DSP structure: H.264 decoding flows (e.g., dequantization, inverse discrete Hadamard transform, intra prediction, and motion decompensation), and non-H.264 decoding flows (e.g., dequantization, row inverse discrete cosine transformation, column inverse discrete cosine transformation, and motion decompensation). The non-H.264 decoding flow can be used for standards such as MPEG1/2/4, H.263, Microsoft WMV9, and Sony Digital Video.

### RELATED APPLICATIONS

This application claims the benefit of U.S. Provisional Application No. 60/635,114, filed on Dec. 10, 2004. In addition, this application is related to U.S. application Ser. No. (not yet known), filed May ______, 2005, titled “Shared Pipeline Architecture for Motion Vector Prediction and Residual Decoding” <attorney docket number 22682-09881>. Each of these applications is herein incorporated in its entirety by reference.

### FIELD OF THE INVENTION

The invention relates to video processing, and more particularly, to digital signal processing structures that can carry out decoding processes such as IDCT and DEQ for multiple video standards (e.g., MPEG1/2/4, H.263, H.264, Microsoft WMV9, and Sony Digital Video).

### BACKGROUND OF THE INVENTION

There are a number of video compression standards available, including MPEG1/2/4, H.263, H.264, Microsoft WMV9, and Sony Digital Video, to name a few. Generally, such standards employ a number of common steps in the processing of video images.

First, video images are converted from RGB format to the YUV format. The resulting chrominance components can then be filtered and sub-sampled of to yield smaller color images. Next, the video images are partitioned into 8×8 blocks of pixels, and those 8×8 blocks are grouped in 16×16 macro blocks of pixels. Two common compression algorithms are then applied. One algorithm is for carrying out a reduction of temporal redundancy, the other algorithm is for carrying out a reduction of spatial redundancy.

Temporal redundancy is reduced by motion compensation applied to the macro blocks according to the picture structure. Encoded pictures are classified into three types: I, P, and B. I-type pictures represent intra coded pictures, and are used as a prediction starting point (e.g., after error recovery or a channel change). Here, all macro blocks are coded without prediction. P-type pictures represent predicted pictures. Here, macro blocks can be coded with forward prediction with reference to previous I-type and P-type pictures, or they can be intra coded (no prediction). B-type pictures represent bi-directionally predicted pictures. Here, macro blocks can be coded with forward prediction (with reference to previous I-type and P-type pictures), or with backward prediction (with reference to next I-type and P-type pictures), or with interpolated prediction (with reference to previous and next I-type and P-type pictures), or intra coded (no prediction). Note that in P-type and B-type pictures, macro blocks may be skipped and not sent at all. In such cases, the decoder uses the anchor reference pictures for prediction with no error.

Spatial redundancy is reduced applying a discrete cosine transform (DCT) to the 8×8 blocks and then entropy coding by Huffman tables the quantized transform coefficients. In particular, spatial redundancy is reduced applying eight times horizontally and eight times vertically a 8×1 DCT transform. The resulting transform coefficients are then quantized, thereby reducing to zero small high frequency coefficients The coefficients are scanned in zigzag order, starting from the DC coefficient at the upper left corner of the block, and coded with variable length coding (VLC) using Huffman tables. The DCT process significantly reduces the data to be transmitted, especially if the block data is not truly random (which is usually the case for natural video). The transmitted video data consists of the resulting transform coefficients, not the pixel values. The quantization process effectively throws out low-order bits of the transform coefficients. It is generally a lossy process, as it degrades the video image somewhat. However, the degradation is usually not noticeable to the human eye, and the degree of quantization is selectable. As such, image quality can be sacrificed when image motion causes the process to lag. The VLC process assigns very short codes to common values, but very long codes to uncommon values. The DCT and quantization processes result in a large number of the transform coefficients being zero or relatively simple, thereby allowing the VLC process to compress these transmitted values to very little data. Note that the transmitter encoding functionality is reversible at the decoding process performed by the receiver. In particular, the receiver performs dequantization (DEQ) and then inverse DCT (IDCT) on the coefficients to obtain the original pixel values.

Conventional implementations for carrying out the DEQ and IDCT receiver processes generally include application specific integrated circuit (ASIC) designs or other purely hardware-based designs without any instruction set. Purely software-based designs are also available. Such pure hardware or software designs generally fail to provide desired flexibility, and are limited to decoding only certain types of video frames (e.g., only one of MPEG1, MPEG2, MPEG4, H.263, H.264, Microsoft WMV9, or Sony Digital Video frames).

Other conventional implementations employ commercial digital signal processors (DSPs), which have general purpose for all types of digital signal processing applications. In such implementations, some of the DSP instruction set and hardware is typically wasted (or otherwise under-utilized), given the demands of a particular application. Moreover, implementation costs are high, particularly for applications using multiple general purpose DSP chips. In addition, the performance of general purpose DSP based systems can be low relative to an ASIC designed for carrying out the video decoding process.

What is needed, therefore, are flexible digital signal processing structures that can carry out decoding processes such as DEQ and IDCT for multiple video standards.

### SUMMARY OF THE INVENTION

One embodiment of the present invention provides a digital signal processor (DSP) for decoding video data. The DSP includes an H.264 decoding flow that operates on video data in a 4×4 sub block basis, and includes dequantization, inverse discrete Hadamard transform, and intra prediction. The DSP further includes a non-H.264 decoding flow that operates on video data on a 8×8 block basis, and includes dequantization, row inverse discrete cosine transformation, and column inverse discrete cosine transformation. The non-H.264 decoding flow can be implemented, for example, using hardware and microcode in a two level architecture, and the H.264 decoding flow can be implemented in a pure hardware solution in a single level architecture. The non-H.264 decoding flow decodes, for instance, at least one of MPEG1, MPEG2, MPEG4, H.263, Microsoft WMV9, and Sony Digital Video coded data.

The DSP may include an FIB FIFO for storing inter predicted data from a frame interpolation block (FIB) in 4×4 sub blocks, with pixel position for each sub block in row by row format. The DSP may include a motion decompensation section for carrying out motion decompensation. This motion decompensation section may further be configured for merging inter predicted data from the FIB FIFO with data received from the decoding flows in row by row format. The DSP may include an ILF FIFO for storing reconstructed data from a motion decompensation section in 4×4 sub blocks, with pixel position for each sub block in row by row format. The DSP may include a dequantizer section for carrying out dequantization on 8×8 blocks in column by column format formed from the 4×4 sub blocks in the VLD FIFO, or directly on the 4×4 sub blocks. The DSP may include a control register for storing picture properties used in the decoding process.

In one particular embodiment, the non-H.264 decoding flow includes a first processor array for carrying out inverse discrete cosine transformation for rows of dequantized 8×8 blocks, wherein each of eight identical processors in the first processor array receive all pixels from a corresponding row of each dequantized 8×8 block. A transpose FIFO is used for transposing 8×8 blocks output by the first processor array. A second processor array is for carrying out inverse discrete cosine transformation for columns of transposed 8×8 blocks received from the transpose FIFO, wherein each of eight identical processors in the second processor array receive all pixels from a corresponding column of each transposed 8×8 block. In another particular embodiment, the H.264 decoding flow includes a prediction line buffer for storing horizontal reference samples of frame data.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a top level block diagram of a digital signal processor configured to carry out decoding processes for multiple video standards in accordance with one embodiment of the present invention;

FIG. 2 illustrates the variable length decoder (VLD) data sequence of the dequantization (DEQ) block of FIG. 1, in accordance with one embodiment of the present invention.

FIG. 3 illustrates row data loading into the processor array for inverse discrete cosine transformation row (IDCTR) block of FIG. 1, in accordance with one embodiment of the present invention.

FIG. 4 illustrates column data loading into the processor array for inverse discrete cosine transformation column (IDCTC) block of FIG. 1, in accordance with one embodiment of the present invention.

FIG. 5 illustrates a five stage pipeline structure of each processor in the IDCTR and IDCTC processor arrays of FIG. 1, in accordance with one embodiment of the present invention.

FIG. 6 illustrates the frame interpolation block (FIB) data sequence of the motion decompensation (DeMC) block of FIG. 1, in accordance with one embodiment of the present invention.

FIG. 7 is a top level block diagram of a digital signal processor configured to carry out H.264 video decoding processes, in accordance with one embodiment of the present invention.

FIG. 8 illustrates an H.264 adaptive 4×4 intra prediction mode scheme configured in accordance with one embodiment of the present invention.

FIG. 9 illustrates an H.264 adaptive 8×8 intra prediction mode scheme configured in accordance with one embodiment of the present invention.

FIG. 10 illustrates an H.264 adaptive 16×16 intra prediction mode scheme configured in accordance with one embodiment of the present invention.

### DETAILED DESCRIPTION OF THE INVENTION

A parallel processing DSP structure using a configurable multi-instruction multi-data (MIMD) processor array in multi-level pipeline architecture is disclosed. The multi-level level pipeline architecture increases the performance of the dequantization (DEQ) and inverse discrete cosine transformation (IDCT) in the decoding process for a number of standards, such as MPEG1/2/4, H.263, H.264, WMV9, and Sony Digital Video (each of which is herein incorporated in its entirety by reference). Each processor in the processor array has a generic instruction set that supports the DEQ and IDCT computations of each video standard. The multi-level level pipeline architecture facilitates the hardware design, which is very efficient in gate counts and power consumption.

In one embodiment, the DSP structure is configured with a two level pipeline structure: a “top” level and a “bottom” level. The top level of the of this two level pipeline has four main sections: DEQ, IDCT for row, IDCT for column, and data alignment. Each section has its own pipeline architecture. The row and column IDCT sections each have an identical processor array, with each array having eight identical generic processors. There are five stages in each processor execution pipe: instruction fetching, instruction decoding, pre-arithmetic execution, arithmetic execution, and register write back. This five stage structure of each processor effectively provides the bottom level of the of the two level pipeline DSP structure.

The top level pipeline includes a column by column data input structure to save a transpose of 8×8 blocks of pixels. The data input sequence is organized in such a way to facilitate the data loading into the processor arrays for the row IDCT and column IDCT. There is one hardware structure for row IDCT and column IDCT to coordinate the loading, storing of data and the instruction execution flow control. Each processor inside the processor arrays has three separate execution pipes. One is for handling multiplication and the other two execution pipes are for handling addition, subtraction, shifting, and clipping. These three pipelines can be executed concurrently. The result of the multiplication pipeline can be forwarded to the other two execution pipes if there is data dependency. There is also a forwarding path inside each processor pipeline architecture.

DSP architectures configured in accordance with an embodiment of the present invention can be structured to communicate with a given decoder system through standard or custom control bus and data bus protocols.

DSP Architecture

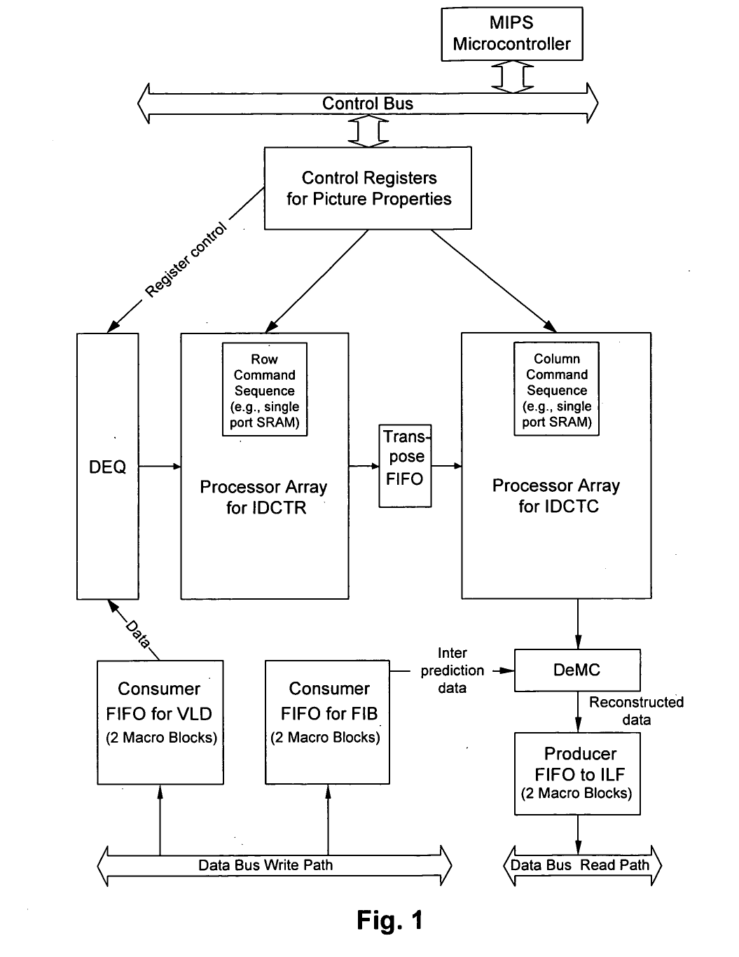

FIG. 1 is a top level block diagram of a DSP configured to carry out decoding processes for multiple video standards in accordance with one embodiment of the present invention. In this particular embodiment, and as previously discussed, the DSP structure is configured with a two level pipeline structure: a top level and a bottom level. Note that the use of the terms top and bottom is not intended to implicate any rigid structural order or architectural limitation. Rather, bottom and top are used to indicate different levels of pipeline processing.

On the top level architecture of this configuration, two decoding flows are enabled. The first one is for H.264 decoding (e.g., dequantization and inverse discrete Hadamard transform), intra prediction, and motion decompensation. This flow can be implemented, for example, as a pure hardware solution in a single level. The operation inside this H.264 flow is on a 4×4 sub block basis. The other decoding flow is for non-H.264 flows, such as MPEG1/2/4, H.263, Microsoft WMV9, and Sony Digital Video. For this flow, the DSP structure carries out the dequantization (DEQ), row inverse discrete cosine transformation (IDCTR) and column inverse discrete cosine transformation (IDCTC), and the motion decompensation (DeMC). The row and column inverse DCT can be implemented, for example, by two processor arrays: one for row inverse DCT, and one for column inverse DCT. In one particular embodiment, the processors inside each processor array has three pipelines that share twenty-four general purpose 32-bit registers. Each pipeline has five pipeline stages: Instruction Fetch, Instruction Decode, PreExecution, Execution, and Write Back To Registers. The operation for this non-H264 flow is on a 8×8 block basis.

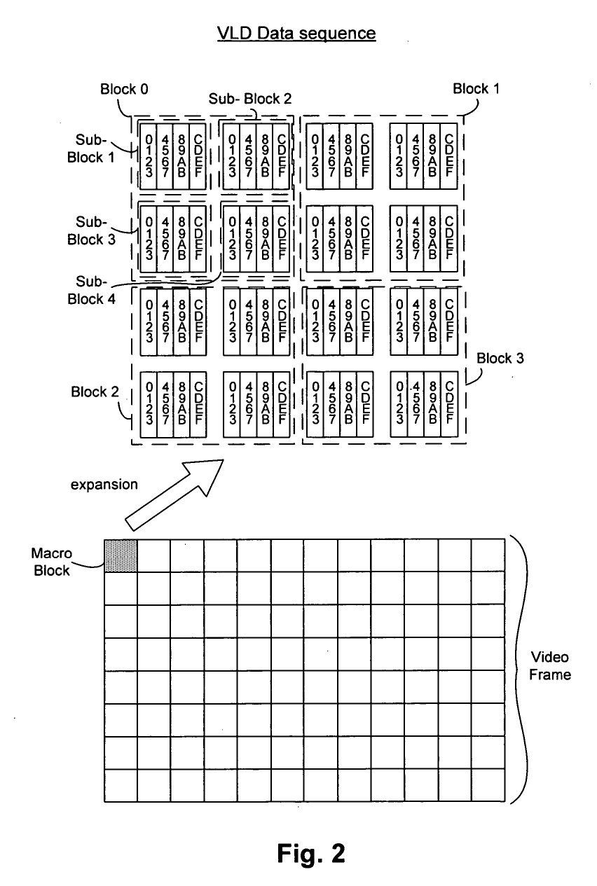

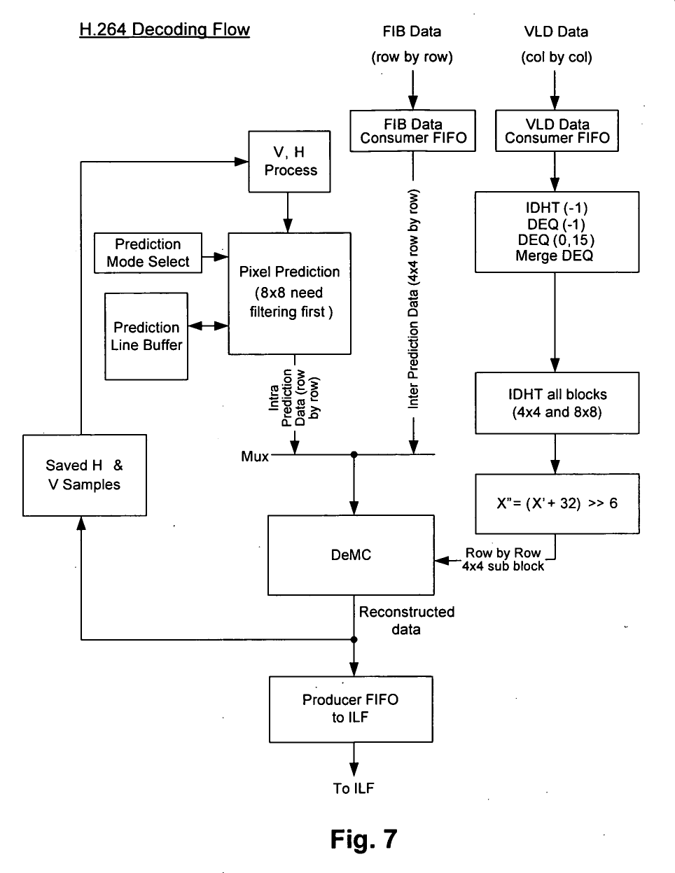

The non-H.264 decoding flow will be discussed in further detail with reference to FIGS. 2 through 6, and the H.264 decoding flow will be discussed in further detail with reference to FIGS. 7 through 10. Note, however, that most of the DSP logic is shared by the H.264 and non-H.264 decoding flows, and that structure and functionality discussed with reference to one flow may also apply to the other flow, as will be apparent in light of this disclosure.

Non-H.264 Decoding Flow

Picture properties are written into the control registers for the picture properties through the control bus. In addition, all the microcodes for carrying out non-H.264 decoding flows, such as MPEG1/2/4 (e.g., MMX mode or Chen-Wang Algorithm), H.263, and WMV9, are loaded into the row command sequence and the column command sequence memories through the control bus. In one embodiment, these memories are each implemented with a single port SRAM. The decoder firmware of the MIPS microcontroller is configured to carry out all loading. Once all the control registers for picture properties are loaded, the decoding flow can begin.

Quantized coefficients from the variable length decoder (VLD) and inter predicted data from frame interpolation block (FIB) are received via the data bus write path. The VLD and FIB sections are not shown in FIG. 1, and can be implemented with conventional or custom technology.

In the embodiment shown in FIG. 1, the quantized coefficients from the VLD are written into the consumer FIFO for VLD. This particular VLD FIFO holds two macro blocks of data, and is arranged in 4×4 sub blocks (e.g., from sub block 0 to sub block 23). Inside each sub block, the pixel position has a column by column format. The data from the VLD FIFO is then transferred to the dequantization (DEQ) section, which is configured to carry out the dequantization operation as normally done. Register control data (e.g., set by the MIPS microcontroller) can be provided to the DEQ section from the control registers for the picture properties. The VLD data sequence of the DEQ is in 8×8 block, column by column format. This data sequence is further explained with reference to FIG. 2.

With reference to FIG. 2, the video frame is divided into macro blocks. For purposes of the discussion herein, assume the video frames are coded in YUV format. Only the decoding for Y (luma) is described, and is based on a 16×16 pixel macro block. Note, however, that decoding for UV (chroma) is similar to Y decoding, but is based on 8×8 pixel blocks. Thus, the complete YUV decoding process will be apparent in light of this disclosure.

In the embodiment shown in FIG. 2, a macro block is 16×16 pixels. Each macro block is divided into four blocks (block 0, block 1, block 2, and block 3). Each block is 8×8 pixels in this embodiment. Each block includes four sub blocks (sub block 1, sub block 2, sub block 3, and sub block 4). Each sub block is 4×4 pixels in this embodiment. Thus, the VLD data input has a sub block 4×4 sequence. As can seen by the pixel numbers (e.g., 0, 1, 2, 3, . . . C, D, E, and F), within every 4×4 sub block, the sequence order is column by column. In one embodiment, the input VLD data sequence (from the data bus write path to the VLD FIFO) has a zigzag pattern through the sub blocks of each block in the order shown.

In more detail, the pixels of sub block 1 of block 0 are loaded into the consumer FIFO for VLD on a column by column basis (pixels 0 through 3, then pixels 4 through 7, then pixels 8 through B, and then pixels C through F). Next, the pixels of sub block 2 of block 0 are loaded on the same column by column basis. Next, the pixels of sub block 3 of block 0 are loaded on the same column by column basis. Next, the pixels of sub block 4 of block 0 are loaded on the same column by column basis. The VLD data sequence then continues with the sub blocks of block 1 in the same zigzag sequence used for the sub blocks of block 0. The VLD data sequence then similarly continues with the sub blocks of block 2, and then the sub blocks of block 3. This process can be repeated for each macro block stored in the consumer FIFO for VLD (which in this embodiment is two macro blocks).

The output from the consumer FIFO for VLD is transferred to the DEQ in an 8×8 block sequence, where the order within each 8×8 block is column by column. Note that this 8×8 block column by column output data sequence is readily achieved, given the 4×4 sub block column by column input VLD data sequence into the VLD FIFO. Further note that other information, such as the macro block control header, can be passed to the decoding flow. In the embodiment shown, the VLD FIFO holds only data, and the macro block control header is added to the decoding flow when the VLD data is passed to the DEQ (e.g., using a macro block control header FIFO between the VLD FIFO and the DEQ). Other flows for associating the VLD data and corresponding macro block control headers will be apparent in light of this disclosure.

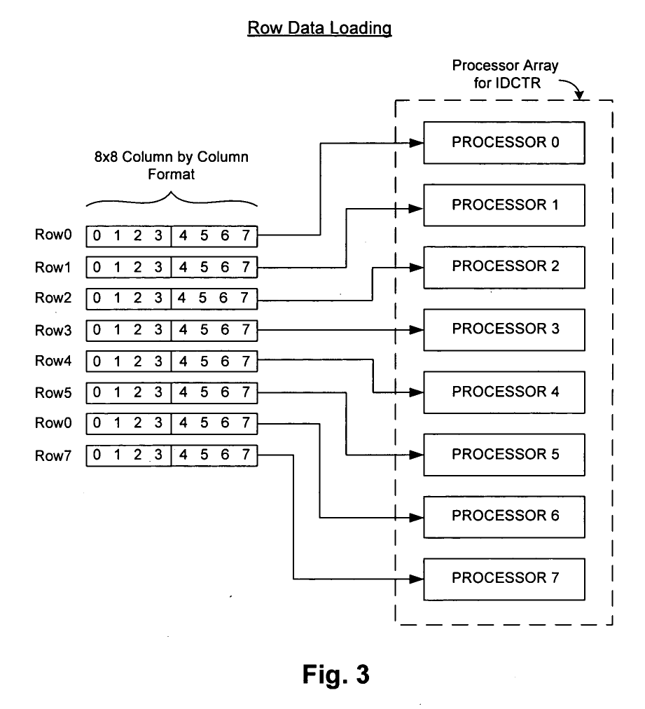

The output from the DEQ is transferred to the processor array for the row inverse discrete cosine transformation (IDCTR) in an 8×8 block sequence, where the order within each 8×8 block is column by column. In this particular embodiment, the processor array for IDCTR has eight identical processors. Given this architecture, when all the DEQ data inside one 8×8 block are transferred to the processor array for IDCTR, the processor 0 of the array will have all row0 pixels in this 8×8 block, processor 1 of the array will have row1 pixels, and so on. All eight processors work concurrently on a corresponding row of the 8×8 block. This architecture for row data loading is further described with reference to FIG. 3.

As can be seen in FIG. 3, the row input data is an 8×8 block sequence. Within every 8×8 block, the order is column by column. In more detail, each of the eight rows has eight pixels (0, 1, 2, . . . 6, 7). Each pixel can be represented, for example, by 16 bits. The order is column by column, in that all eight pixels 0 (forming the first column of the 8×8 block) are concurrently loaded into a corresponding one or the eight processors (processor 0 through processor 7). Then, all eight pixels 1 (forming the second column of the 8×8 block) are concurrently loaded into a corresponding one or the eight processors. Then, all eight pixels 2 (forming the third column of the 8×8 block) are concurrently loaded into a corresponding one or the eight processors. This column by column loading continues until all eight pixels 7 (forming the eighth column of the 8×8 block) are concurrently loaded into a corresponding one or the eight processors. Once loaded, all eight processors of the IDCTR processor array work concurrently on a corresponding row of the 8×8 block.

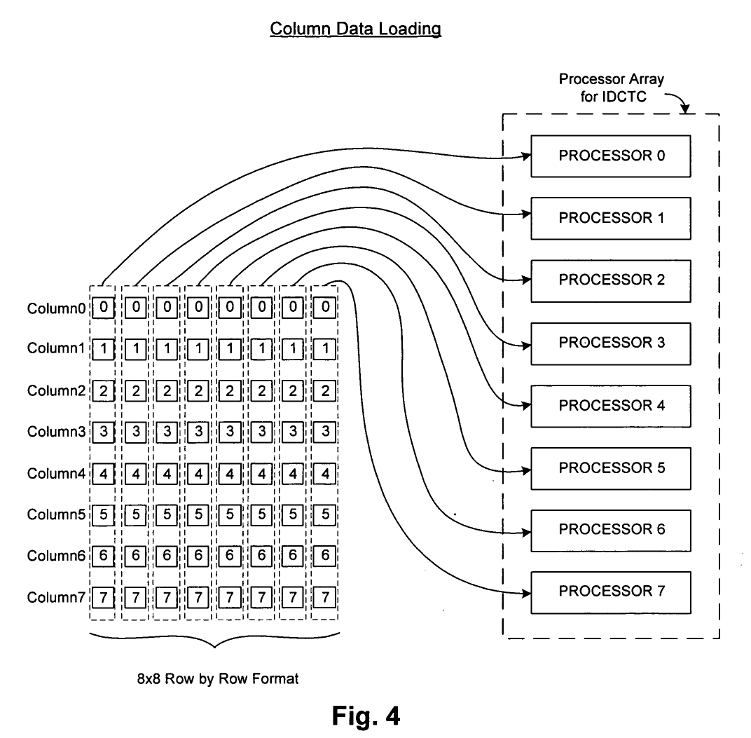

The output of the processor array for IDCTR is then provided to a transpose FIFO, as shown in FIG. 1. This transpose FIFO is for transposing 8×8 blocks output by the IDCTR processor array, in preparation for processing by the processor array for the column inverse discrete cosine transformation (IDCTC). Thus, column data is input to the processor array for IDCTC in an 8×8 block sequence, where the order within each 8×8 block is row by row. The column operation is similar to the row operation as previously described, and architecture for column data loading is further described with reference to FIG. 4.

As can be seen in FIG. 4, the column input data is an 8×8 block sequence. Within every 8×8 block, the order is row by row. In more detail, each of the eight columns has eight pixels (0, 1, 2, . . . 6, 7). Each pixel can be represented, for example, by 16 bits. The order is row by row, in that all eight pixels 0 (forming the first row of the 8×8 block) are concurrently loaded into a corresponding one or the eight processors (processor 0 through processor 7). Then, all eight pixels 1 (forming the second row of the 8×8 block) are concurrently loaded into a corresponding one or the eight processors. Then, all eight pixels 2 (forming the third row of the 8×8 block) are concurrently loaded into a corresponding one or the eight processors. This row by row loading continues until all eight pixels 7 (forming the eighth row of the 8×8 block) are concurrently loaded into a corresponding one or the eight processors. Once loaded, all eight processors (processor 0 through processor 7) of the IDCTC processor array work concurrently on a corresponding column of the 8×8 block.

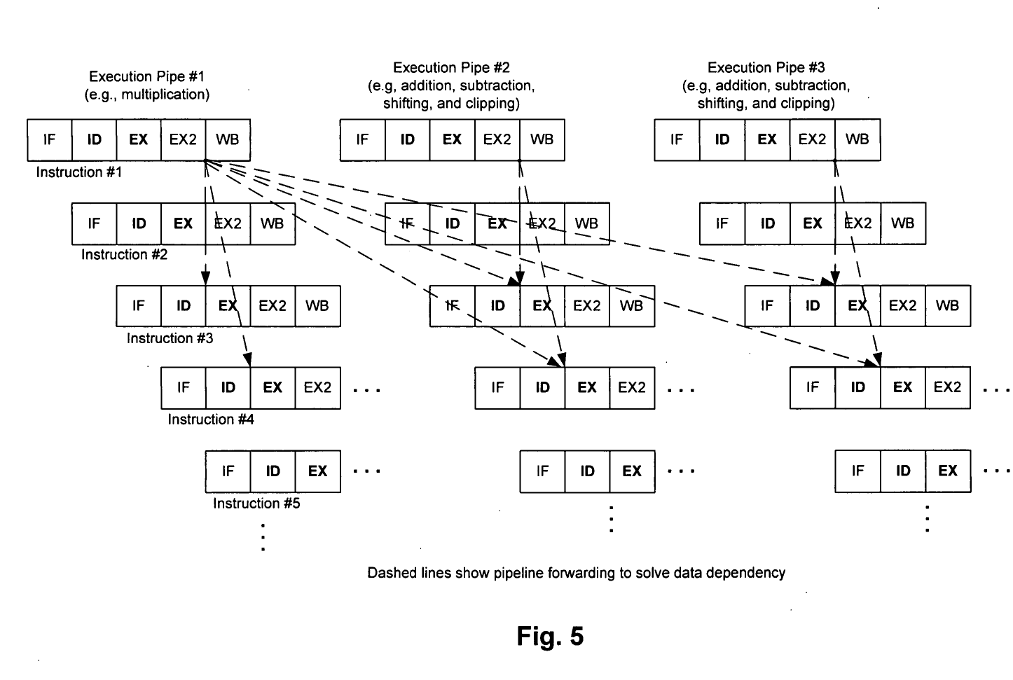

In one embodiment, each of the processors inside the IDCTR and IDCTC processor arrays are identical and has an instruction set as shown in Table 1 and a pipeline stage structure as shown in FIG. 5.

TABLE 1
Instruction Set for Processor

| encode | 000 | 001 | 010 | 011 | 100 | 101 | 110 | 111 |
|---|---|---|---|---|---|---|---|---|
| 00 | NOP | LOAD | STORE | ** | End | ** | ** | ** |
| 01 | ADDShtL | ADDShtR | ADDCShtR | ADDi | ** | ** | ** | ** |
| 11 | SUBShtL | SUBShtR | ** | SUBi | ** | ** | ** | ** |
| 10 | MULi | MuliShtR16 | MulC | ** | ** | ** | ** | ** |

The LOAD instruction is used for loading data (e.g., row or column) into processor registers. The NOP (no operation) instruction can be used for delay purposes. The STORE instruction is used for storing data (e.g., row or column) into processor registers or other memory (internal or external). The ADDShtL instruction can be used to carry out add with shift left operations on data registers of the processor. The ADDShtR instruction can be used to carry out add with shift right operations on data registers of the processor. The ADDCShtR instruction can be used to carry out add with carry and shift right operations on data registers of the processor. The SUBShtL instruction can be used to carry out subtract with shift left operations on data registers of the processor. The SUBShtR instruction can be used to carry out subtract with shift right operations on data registers of the processor. For such shift operations, note that clipping and shift amounts can be specified in the instruction syntax. The ADDi instruction can be used to carry out add immediate operations on data registers of the processor, the SUBi instruction can be used to carry out subtract immediate operations on data registers of the processor, and the MULi instruction can be used to carry out multiply immediate operations on data registers of the processor. For such immediate operations, the sign-extended immediate value can be specified. The MulC instruction can be used to carry out multiply with carry operations on data registers of the processor. The MULiShtR16 instruction can be used to carry out multiply immediate with shift right operations on data registers of the processor.

Example format for the instruction set is as follows:

| | | | | | | |
|---|---|---|---|---|---|---|
| LOAD: | OP(5 bits) | 5′b0 | RT(5 bits) | 17′b0 | | |
| STORE: | OP(5 bits) | RS0(5 bits) | 5′b0 | 17′b0 | | |
| ADDShtL: | OP(5 bits) | RS0(5 bits) | RT(5 bits) | RS1(5 bits) | 7′b0 | Clip(1) |
| ShtMnt(4) | | | | | | |
| ADDShtR: | OP(5 bits) | RS0(5 bits) | RT(5 bits) | RS1(5 bits) | 7′b0 | Clip(1) |
| ShtMnt(4) | | | | | | |

NOTE: if clip enabled, clip first then shift; 4 bits for shift amount enables 0 to 15 bit
shift.

| | | | | | | |
|---|---|---|---|---|---|---|
| ADDCShtR: | OP(5 bits) | RS0(5 bits) | RT(5 bits) | 12′b0 | Clip(1) | ShtMnt(4) |

(RS0 + MMXRounder >> 11 and saved to RT)
NOTE: if clip enabled, shift first then clip; 4 bits for shift amount enables 0 to 15 bit
shift.

| | | | | | | |
|---|---|---|---|---|---|---|
| SUBShtL: | OP(5 bits) | RS0(5 bits) | RT(5 bits) | RS1(5 bits) | 7′b0 | Clip(1) |
| ShtMnt(4) | | | | | | |
| SUBShtR: | OP(5 bits) | RS0(5 bits) | RT(5 bits) | RS1(5 bits) | 7′b0 | Clip(1) |
| ShtMnt(4) | | | | | | |

NOTE: if clip enabled, clip first then shift; 4 bits for shift amount enables 0 to 15 bit
shift.

| ADDi: | OP(5 bits) | RS0(5 bits) | RT(5 bits) | Clip(1) | IMM(16 bits) |
|---|---|---|---|---|---|
| SUBi: | OP(5 bits) | RS0(5 bits) | RT(5 bits) | Clip(1) | IMM(16 bits) |
| MULi | OP(5 bits) | RS0(5 bits) | RT(5 bits) | 1′b0 | IMM(16 bits) |
| MulC | OP(5 bits) | RS0(5 bits) | RT(5 bits) | RC(3 bits) | 14′b0 |

| | | | | | |
|---|---|---|---|---|---|
| MULiShtR16 | OP(5 bits) | RS0(5 bits) | RT(5 bits) | 1′b0 | IMM(16 bits) |

Result right shifted 16 bits

Note that: OP=operation code; RS=first register source operand; RT=second register source operand; RC=constant register; ShtMnt=shift amount; Clip=clipping enabled/disabled for a shift operation; MMXRounder=MMX mode rounder register; and IMM=sign-extended immediate value. Various instruction sets can be used here, as will be apparent in light of this disclosure.

All microcode (e.g., for MPEG1/2/4, H.263, and WMV9) can be written using the instruction set shown in Table 1, and compiled as binary code by a C program, as conventionally done. These binary codes can be saved into the row command sequence and column command sequence memories (shown in FIG. 1) by the MIPS microcontroller.

FIG. 5 illustrates a five stage pipeline structure of each processor in the IDCTR and IDCTC processor arrays of FIG. 1, in accordance with one embodiment of the present invention. As can be seen, each processor has three separate execution pipes. In this embodiment, execution pipe #1 is for handling multiplication, and execution pipes #2 and #3 are for handling addition, subtraction, shifting, and clipping. These three execution pipes can be executed concurrently. Each execution pipe has five stages: Instruction Fetch (IF), Instruction Decode (ID), PreExecution (EX), Execution (EX2), and Write Back To Registers (WB). As previously stated, this five stage pipeline structure of each processor effectively provides the bottom level of the of the two level pipeline DSP structure.

Note that, if there is data dependency, the result of the multiplication pipeline (e.g., from instruction #1) can be forwarded within the multiplication pipeline (e.g., to instructions #3 and #4), as well as to the both execution pipes #2 and #3 (e.g., to instructions #3 and #4). There is also a forwarding path inside each of execution pipes #2 and #3 (e.g., from instruction #1 to instructions #3 and #4). In one particular such embodiment, the processors are each implemented with a conventional reduced instruction set computer (RISC) processor, where each of the three pipelines share twenty-four general purpose 32-bit registers.

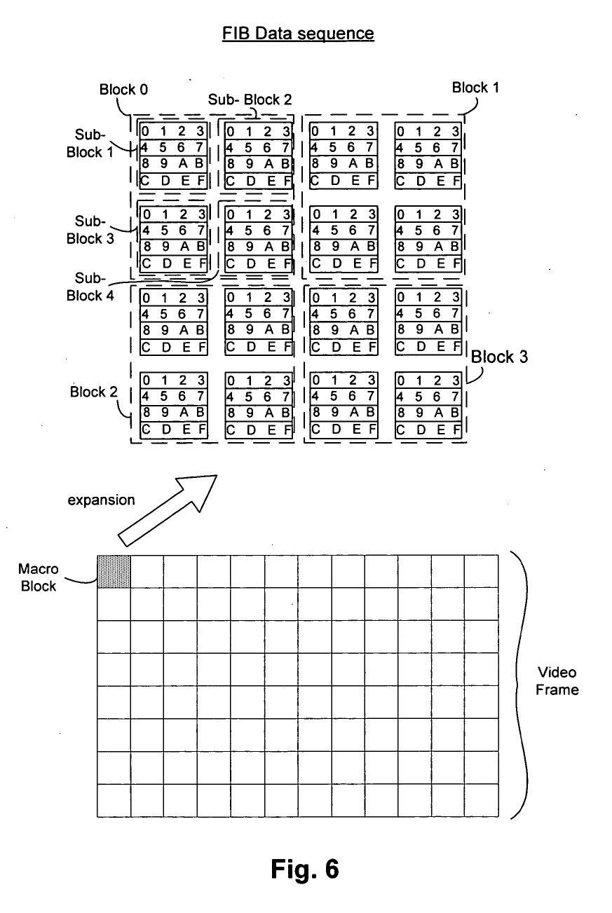

In the embodiment shown in FIG. 1, the inter predicted data from the FIB are written into the consumer FIFO for FIB. This particular FIB FIFO holds two macro blocks of data, and is arranged in 4×4 sub blocks (e.g., from sub block 0 to sub block 23). Inside each sub block, the pixel position has a row by row format. The data from the FIB FIFO is merged with the data from the IDCTC processor array in 8×8 row by row block format within the DeMC section, which carries out motion decompensation as normally done. The FIB data sequence to the consumer FIFO for FIB (from the data bus write path) is further explained with reference to FIG. 6.

With reference to FIG. 6, the video frame is divided into macro blocks (assume the video frames are coded in YUV format as previously discussed). In this embodiment, a macro block is 16×16 pixels. Each macro block is divided into four blocks (block 0, block 1, block 2, and block 3). Each block is 8×8 pixels in this embodiment. Each block includes four sub blocks (sub block 1, sub block 2, sub block 3, and sub block 4). Each sub block is 4×4 pixels in this embodiment. Thus, the FIB data input has a sub block 4×4 sequence. As can seen by the pixel numbers (e.g., 0, 1, 2, 3 . . . C, D, E, and F), within every 4×4 sub block, the sequence order is row by row. In one embodiment, the input FIB data sequence (from the data bus write path to the consumer FIFO for FIB) has a zigzag pattern through the sub blocks of each block in the order shown.

In more detail, the pixels of sub block 1 of block 0 are loaded into the FIB FIFO on a row by row basis (pixels 0 through 3, then pixels 4 through 7, then pixels 8 through B, and then pixels C through F). Next, the pixels of sub block 2 of block 0 are loaded on the same row by row basis. Next, the pixels of sub block 3 of block 0 are loaded on the same row by row basis. Next, the pixels of sub block 4 of block 0 are loaded on the same row by row basis. The FIB data sequence then continues with the sub blocks of block 1 in the same zigzag sequence used for the sub blocks of block 0. The FIB data sequence then similarly continues with the sub blocks of block 2, and then the sub blocks of block 3. This process can be repeated for each macro block stored in the consumer FIFO for FIB (which in this embodiment is two macro blocks).

As previously discussed, the output from the consumer FIFO for FIB is merged with the data from the IDCTC processor array in 8×8 row by row block format within the DeMC section. Note that this 8×8 block row by row output data sequence is readily achieved, given the 4×4 sub block row by row input FIB data sequence into the FIB FIFO.

After the motion compensation is performed by the DeMC, all the 8×8 row by row block format reconstructed data is saved inside the producer FIFO to the in-loop filter (ILF), transformed into 4×4 row by row sub block format, and transferred to the ILF. In one particular embodiment, the producer FIFO to ILF is implemented as dual port SRAM, and the mapping from 8×8 row by row block format to 4×4 row by row block format is handled through address mapping logic. Note that this also includes interlacing for non-H.264 decoding flows. The interlacing for H.264 is typically done in the ILF.

The producer ILF FIFO then transfers the reconstructed data to the ILF based on, for example, the internal data bus read path protocol, which in one embodiment has a burst transfer size of 1 macro block. The ILF section is not shown in FIG. 1, and can be implemented with conventional or custom technology.

H.264 Decoding Flow

As previously indicated, the decoding flow for H.264 can be implemented with a purely hardware solution on a single level. The architecture of one such embodiment is shown in FIG. 7. As previously discussed, most of the logic inside the DSP structure is shared by the H.264 and non-H.264 decoding flows. With this in mind, note that the H.264 architecture can be integrated with (or otherwise be a part of) the non-H.264 flow architecture. The main differences between the two flows is that H.264 flow has intra prediction capability and a prediction line buffer, while the non-H.264 flow has a row processor array and a column processor array (with each array having microcode as previously discussed). Thus, both the H.264 and non-H.264 decoding flows can be implemented with a single architecture. Note, however, in H.264 mode, all the non-H.264 mode decoding logic can be shut down to save power, and vice-versa. Also, all decoding logic can be shut down during idle states. Various power consumption saving schemes can be used here.

In this case, the H.264 decoding flow has a 4×4 sub block basis. The VLD FIFO and the FIB FIFO are similar to the non-H.264 flow as previously discussed. As such, discussion with reference to FIGS. 2 and 6 are equally applicable here. The VLD FIFO data is processed through the DEQ and inverse discrete Hadamard transform (IDHT) (or other suitable IDCT) and last the rounding. The IDHT(−1), DEQ(−1), DEQ(0,15), and merge DEQ functions can all be implemented with conventional technology in accordance with the H.264 standard. In one particular embodiment of the H.264 decoding flow, a H.264 DEQ section (i.e., separate from the DEQ section shown in FIG. 1) is configured to carryout DEQ(−1), DEQ(0,15), and merge DEQ functions. Likewise, an IDHT module can be configured to perform IDHT of block −1 and blocks 16 and 17, as well as IDHT of all regular blocks (0 through 15). In addition, a rounding module can be configured to perform the X″=(X′+32)>>6 process for the H.264 decoding flow.

The producer ILF FIFO then transfers the reconstructed data to the ILF based on, for example, the internal data bus read path protocol, which in one embodiment has a burst transfer size of 1 macro block. The ILF section is not shown in FIG. 1, and can be implemented with conventional or custom technology. The producer ILF FIFO structure and function is similar to the non-H.264 flow as previously discussed, and that discussion is equally applicable here.

The decoded or “reconstructed” data is saved on the sub block boundary. These boundaries are the vertical reference and horizontal reference. The reference samples are calculated based on the current vertical/horizontal reference and the sample data inside the prediction line buffer coupled to the pixel prediction section, which can be implemented, for example, with conventional technology in accordance with the H.264 standard. In one embodiment, the prediction line buffer is implemented with a single port SRAM.

If the prediction mode is 8×8, the reference sample is processed through a filtering operation before the intra prediction is performed. In the embodiment shown in FIG. 7, the prediction mode select register is used to set the intra prediction mode, of which there are three: 4×4, 8×8, and 16×16. For each of these modes, the intra prediction can be adaptive or non-adaptive. The register can be set, for example, by the MIPS microcontroller. If the current macro block is intra prediction mode, the predicted data is added via the DeMC to the decoded data after rounding. Otherwise, the inter predicted data from the FIB FIFO is added to the decoded data via the DeMC. The multiplexer (Mux) in this embodiment is used to switch in one of the intra or inter predicted data, depending on the macro block mode, which can be inter prediction or intra prediction. Note that the information to control the multiplexer is indicated inside the macro block control header.

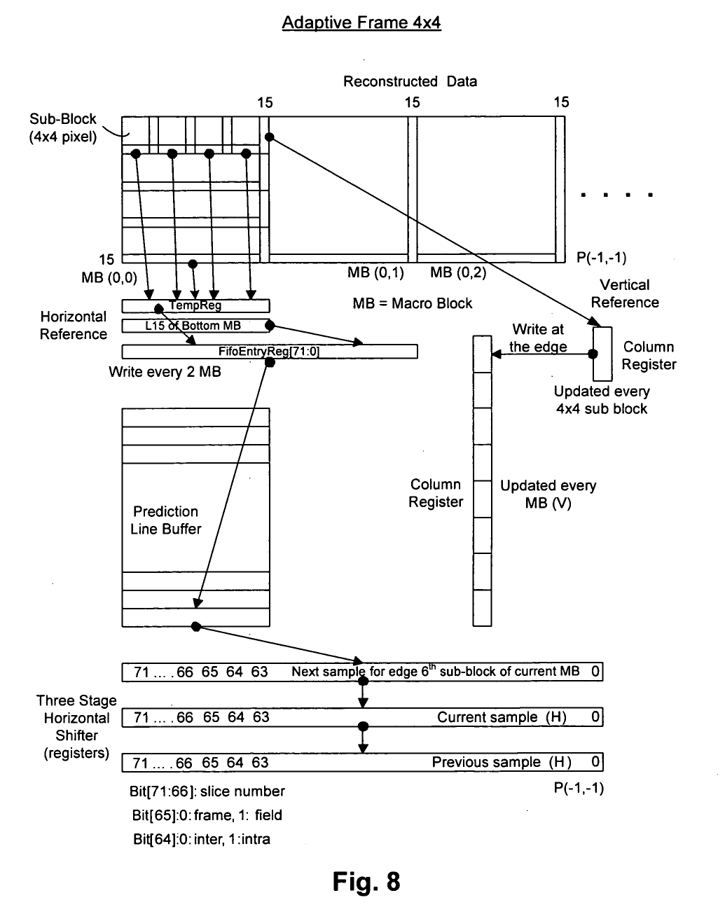

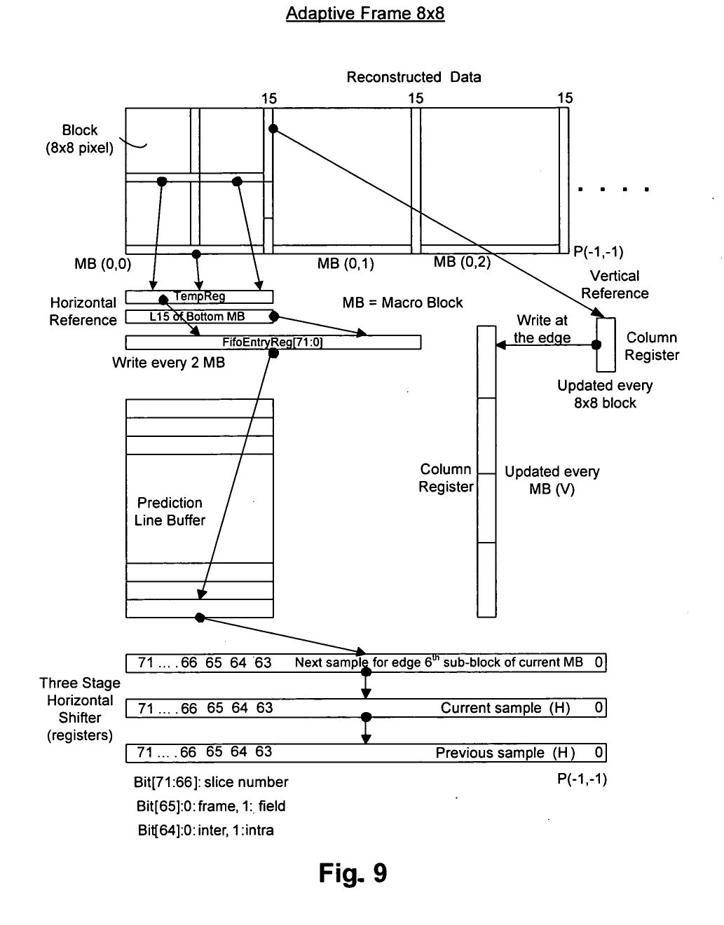

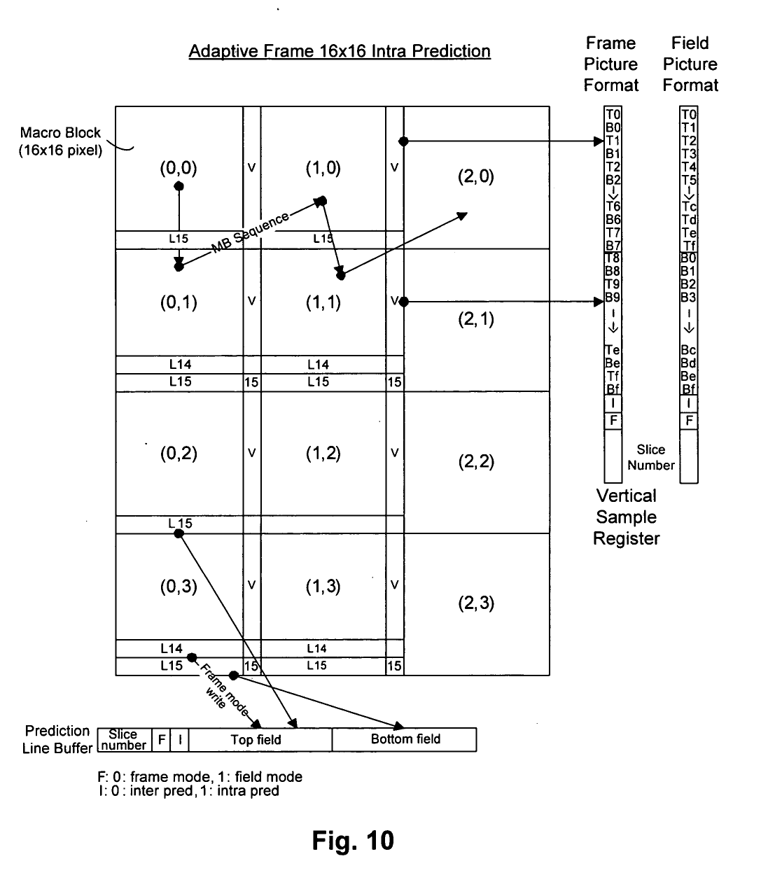

A 4×4 intra prediction mode scheme is shown in FIG. 8, an 8×8 intra prediction mode scheme is shown in FIG. 9, and a 16×16 intra prediction mode scheme is shown in FIG. 10. As can be seen, the intra prediction flows for the 4×4, 8×8, and 16×16 schemes each have a similar structure. Note that horizontal register details are shown in FIGS. 8 and 9, while vertical register detail is shown in FIG. 10. It will be appreciated, however, that each intra prediction mode scheme includes both horizontal and vertical register details. The main control of the flow is the sub block counter, which is implemented within the pixel prediction module of this embodiment. The sub block count points to the relative position for the current 4×4 sub block.

Depending on the intra prediction mode, the proper reference sample is calculated and used for the intra prediction for the current sub block. For every 4×4 sub block, the vertical and horizontal samples are saved in the Saved H & V Samples section of FIG. 7) and used for the next sub block. The V, H Process section in FIG. 7 determines what samples are selected from the Saved H & V Samples section. The Pixel Prediction section of FIG. 7 performs conventional pixel intra prediction in accordance with the H.264 standard (e.g., using addition, shifting, etc).

At the end of every macro block, all the vertical and horizontal samples are saved. The vertical samples are used for the next macro block. The horizontal samples are saved into the prediction line buffer, and are used as horizontal reference samples for the macro block of the next row. Adaptive frame pictures have a similar structure, but the size of the prediction line buffer is doubled in the reference sample storage. The output of the prediction line buffer is saved in the three stage horizontal shifter. All the three entries inside the shifter are used as horizontal reference samples. They correspond to previous horizontal sample, current horizontal sample, and next horizontal sample, respectively.

In more detail, and with reference to FIG. 8, a portion of a frame is shown. As can be seen, the frame is divided into 4×4 sub block (16 pixels). These sub blocks are grouped together to form 8×8 blocks (64 pixels). These blocks are grouped together to form 16×16 macro blocks (256 pixels). The macro block properties are stored in the prediction line buffer. Each entry is associated with a horizontal reference and a vertical reference.

In this example, the horizontal reference is one row of sixteen pixels (where each of the four downward pointing arrows shown in FIG. 8 represent four pixels from the current row). The row is stored in the TempReg, and row 15 (L15) of the bottom macro block (MB) is stored in its corresponding register (for adaptive mode). The content of these registers are then concatenated and stored into the FifoEntryReg[71:0]. This is done for two macro blocks (for a total of 64 bits). The FifoEntryReg[71:0] is written to the prediction line buffer every two macro blocks. The line buffer can be, for example, a 960×80 single port SRAM.

The vertical reference is provided by the four columns corresponding to the horizontal reference row. These macro block properties are stored in a vertical register (where the right and downward pointing arrow represents four pixels from one of the four current columns). For intra mode prediction, this vertical register is updated every 4×4 sub block (e.g., for Main Profile). This register is written out to another larger vertical register that collects and holds all properties for each macro block. This larger vertical register is updated for every macro block.

A three stage horizontal shifter receives macro block property data from the line buffer, and is configured with three horizontal shift registers in this embodiment: a previous sample (H) register, a current sample (H) register, and a next sample for the edge 6^{th} sub block of the current macro block register. As can be seen, bits 71 to 66 represent the slice number, bit 65 is used to indicate frame or field picture (e.g., 0=frame; 1=field), and bit 64 is used to indicate inter or intra prediction mode (e.g., 0=inter; 1=intra). Bits 63 to 0 can be used for the sample reference pixel.

The macro block property format stored in the macro block property shifter can be as follows: REF0, REF1, Frame/Field picture, Slice, Intra/Inter prediction, Forward/Backward prediction, MV0, MV1. Here, MV is motion vector, REF is reference picture ID, 0 (zero) is for forward and 1 (one) is for backward. Thus, MV0 is the forward motion vector, MV1 is the backward motion vector, REF0 is the forward reference picture ID, and REF1 is the backward reference picture ID. Numerous register formats can be used here, and the present invention is not intended to be limited to any one such format. Also, while the pixels themselves are being processed in these embodiments, note that the motion vector macro block properties (associated with each sub block) of the motion vector prediction as discussed in the previously incorporated U.S. application No. (not yet known), filed May ______, 2005, titled “Shared Pipeline Architecture for Motion Vector Prediction and Residual Decoding” <attorney docket number 22682-09881>, can also be processed with a similar structure, as discussed here in the intra prediction structure.

FIG. 9 show an adaptive frame 8×8 flow that is similar to the 4×4 frame flow. Here, the horizontal reference is one row of sixteen pixels (where each of the two downward pointing arrows shown in FIG. 9 represent eight pixels from the current row). The remainder of the flow is the same, except that the vertical register is updated every 8×8 block (e.g., for High Profile).

FIG. 10 show an adaptive frame 16×16 flow that is similar to the 4×4 and 8×8 frame flows. Here, the horizontal reference is one row of sixteen pixels (where the downward pointing arrow shown in FIG. 10 represent sixteen pixels from the current row). Here, details of the vertical sample register are shown. The vertical register format for both a frame picture and a field picture is shown. As can be seen, the frame picture format alternates between top and bottom fields (e.g., T0 and B0, then T1 and B1, etc.), while a field picture format is top fields first (e.g., T0, T1, T2, etc.) and then bottom fields (e.g., B0, B1, B2, etc.).

Note that the slice number, as well as the field mode or frame mode (F) and the inter prediction or intra prediction mode (I), can be specified in each of the line buffer and vertical sample register. The horizontal shift register (not shown in FIG. 10) can be implemented as discussed in reference to FIGS. 8 and 9. Further note that, even though the 4×4, 8×8, and 16×16 macro block structures are discussed separately, the DSP structure can process macro block structures in random order (e.g., 4×4, then 16×16, then 4×4, then 8×8, etc).

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A digital signal processor for decoding video data, comprising:
a VLD FIFO for storing quantized coefficients from a variable length decoder (VLD) in 4×4 sub blocks, with pixel position for each sub block in column by column format;
a dequantizer section for carrying out dequantization on 8×8 blocks in column by column format formed from the 4×4 sub blocks in the VLD FIFO;
a first processor array for carrying out inverse discrete cosine transformation for rows of dequantized 8×8 blocks received from the dequantizer section, wherein each of eight identical processors in the first processor array receive all pixels from a corresponding row of each dequantized 8×8 block;
a transpose FIFO for transposing 8×8 blocks output by the first processor array;
a second processor array for carrying out inverse discrete cosine transformation for columns of transposed 8×8 blocks received from the transpose FIFO, wherein each of eight identical processors in the second processor array receive all pixels from a corresponding column of each transposed 8×8 block; and
a motion decompensation section for carrying out motion decompensation on 8×8 blocks received from the second processor array.

2. The digital signal processor of claim 1 further comprising:
an FIB FIFO for storing inter predicted data from a frame interpolation block (FIB) in 4×4 sub blocks, with pixel position for each sub block in row by row format.

3. The digital signal processor of claim 2 wherein the motion decompensation section is further configured to merge inter predicted data from the FIB FIFO with data output by the second processor array in 8×8 blocks in row by row format.

4. The digital signal processor of claim 1 further comprising:
an ILF FIFO for storing reconstructed data from the motion decompensation section in 4×4 sub blocks, with pixel position for each sub block in row by row format.

5. The digital signal processor of claim 4 wherein the ILF FIFO is implemented as a dual port SRAM, and mapping from 8×8 blocks provided by the motion decompensation section to 4×4 sub blocks is carried out using address mapping logic.

6. The digital signal processor of claim 1 further comprising: a control register for storing picture properties used in decoding process.

7. The digital signal processor of claim 1 wherein the digital signal processor is configured to carry out a plurality of decoding flows, including an H.264 decoding flow and a non-H.264 decoding flow.

8. The digital signal processor of claim 7 wherein the H.264 decoding flow is implemented in a pure hardware solution in a single level architecture that shares architecture of the non-H.264 decoding flow.

9. The digital signal processor of claim 8 wherein the H.264 decoding flow includes dequantization, inverse discrete Hadamard transform, intra prediction, and motion decompensation.

10. The digital signal processor of claim 7 wherein the non-H.264 decoding flow is implemented using hardware and microcode in a two level architecture.

11. The digital signal processor of claim 10 wherein the non-H.264 decoding flow includes dequantization, row inverse discrete cosine transformation, column inverse discrete cosine transformation, and motion decompensation.

12. The digital signal processor of claim 7 wherein the non-H.264 decoding flow decodes at least one of MPEG1, MPEG2, MPEG4, H.263, Microsoft WMV9, and Sony Digital Video coded data.

13. The digital signal processor of claim 7 wherein operation in the H.264 flow is on a 4×4 sub block basis, and operation in the non-H264 flow is on a 8×8 block basis.

14. A digital signal processor for decoding video data, comprising:
a VLD FIFO for storing quantized coefficients from a variable length decoder (VLD) in 4×4 sub blocks, with pixel position for each sub block in column by column format;
an H.264 decoding flow that operates on data from the VLD FIFO on a 4×4 sub block basis, and includes dequantization, inverse discrete Hadamard transform, and intra prediction;
a non-H.264 decoding flow that operates on data from the VLD FIFO on an 8×8 block basis, and includes dequantization, row inverse discrete cosine transformation, and column inverse discrete cosine transformation; and
a motion decompensation section for carrying out motion decompensation on data received from the decoding flows.

15. The digital signal processor of claim 14 further comprising:
an FIB FIFO for storing inter predicted data from a frame interpolation block (FIB) in 4×4 sub blocks, with pixel position for each sub block in row by row format.

16. The digital signal processor of claim 15 wherein the motion decompensation section is further configured to merge inter predicted data from the FIB FIFO with data output by the second processor array in 8×8 blocks in row by row format.

17. The digital signal processor of claim 14 further comprising:
an ILF FIFO for storing reconstructed data from the motion decompensation section in 4×4 sub blocks, with pixel position for each sub block in row by row format.

18. The digital signal processor of claim 14 further comprising: a control register for storing picture properties used in decoding process.

19. The digital signal processor of claim 14 wherein the non-H.264 decoding flow comprises:
a first processor array for carrying out inverse discrete cosine transformation for rows of dequantized 8×8 blocks, wherein each of eight identical processors in the first processor array receive all pixels from a corresponding row of each dequantized 8×8 block;
a transpose FIFO for transposing 8×8 blocks output by the first processor array; and
a second processor array for carrying out inverse discrete cosine transformation for columns of transposed 8×8 blocks received from the transpose FIFO, wherein each of eight identical processors in the second processor array receive all pixels from a corresponding column of each transposed 8×8 block.

20. The digital signal processor of claim 14 wherein the H.264 decoding flow is implemented in a pure hardware solution, and further includes a prediction line buffer for storing horizontal reference samples of frame data.

21. The digital signal processor of claim 14 wherein the non-H.264 decoding flow decodes at least one of MPEG1, MPEG2, MPEG4, H.263, Microsoft WMV9, and Sony Digital Video coded data.

22. A digital signal processor for decoding video data, comprising:
an H.264 decoding flow that operates on video data in a 4×4 sub block basis, and includes dequantization, inverse discrete Hadamard transform, and intra prediction; and
a non-H.264 decoding flow that operates on video data on a 8×8 block basis, and includes dequantization, row inverse discrete cosine transformation, and column inverse discrete cosine transformation.

23. The digital signal processor of claim 22 further comprising:
an FIB FIFO for storing inter predicted data from a frame interpolation block (FIB) in 4×4 sub blocks, with pixel position for each sub block in row by row format; and
a motion decompensation section for merging inter predicted data from the FIB FIFO with data received from the decoding flows in row by row format, and for carrying out motion decompensation.

24. The digital signal processor of claim 23 further comprising:
an ILF FIFO for storing reconstructed data from the motion decompensation section in 4×4 sub blocks, with pixel position for each sub block in row by row format.

25. The digital signal processor of claim 22 wherein the non-H.264 decoding flow is implemented using hardware and microcode in a two level architecture, and the H.264 decoding flow is implemented in a pure hardware solution in a single level architecture.
